(19) United States
(12) Patent Application Publication
(10) Pub. No.: US 2023/0349826 A1
(43) Pub. Date: Nov. 2, 2023

(54) BACKGROUND INSENSITIVE REFLECTOMETRIC OPTICAL METHODS AND SYSTEMS USING THE SAME

(71) Applicants: ALI KEMAL OKYAY, PALO ALTO, CA (US); AYKUTLU DANA, PALO ALTO, CA (US)

(72) Inventors: ALI KEMAL OKYAY, PALO ALTO, CA (US); AYKUTLU DANA, PALO ALTO, CA (US)

(21) Appl. No.: 18/041,406

(22) PCT Filed: Sep. 20, 2021
(86) PCT No.: PCT/US2021/051058

§ 371 Date: Feb. 11, 2023

Related U.S. Application Data
(60) Provisional application No. 63/081,233, filed on Sep. 21, 2020.

(51) Int. Cl. G01N 21/552

(52) U.S. Cl. CPC G01N 21/554

(57) ABSTRACT

Described herein are systems and methods for detection of molecular analytes in a buffer solution. The system and methods utilize a surface plasmonic resonance methodology tied to a standardized diffraction reference value and an array spectrometer for greater stability in testing.

### CROSS-REFERENCE TO RELATED APPLICATIONS

This application claims priority from U.S. Provisional Patent application 63/081,233, entitled “Background Insensitive Plasmon Resonance Sensing Methods and Systems Using the Same”, filed on Sep. 21, 2020. The contents of which are herein incorporated by reference in their entirety.

### BACKGROUND

The present disclosure is in the field of optical biomolecular sensors. In particular, the present disclosure is related to the field of surface plasmon resonance sensing.

### BRIEF SUMMARY

Detection of various biomolecules continues to be a much needed test element of modern medicine and science. The spread of various diseases, pollutants and allergens cause the body of a patient to react and produce various antibodies, proteins and enzymes. Often it is easier to detect the body's response to a disease or foreign particle than to track the disease or foreign particle itself. Detection methods and devices have improved over the years, and plasmon resonance sensing is a type of biomolecule sensor that may have commercial promise.

Described herein are sensors, systems and methods for a form of plasmon resonance sensing that may enable a higher throughput of test samples in a given time period.

In an embodiment, there is described a method for detection of a test sample using a surface plasmon resonance detection system, the method involving: placing the test sample in to a receptacle, transmitting a beam of light, via a light source, through the test sample and to a thin film stack, wherein the beam of light is off an orthogonal axis of the thin film stack. Receiving, via a spectrometer, a first reflected light off the thin film stack and receiving, via a diffraction sensor, a second reflected light; and analyzing, via a computer controller, the first and second reflected lights to determine if the test sample contains a molecular analyte wherein the surface plasmon resonance is used to determine the presence of the molecular analyte.

In another embodiment, there is described a system for surface plasmon resonance sensor measurement, the system including a grating with at least one period selected based on a given angle of incidence so a plasmon resonance is observed in an optical reflection spectrum, or a diffracted spectrum, with a resonance peak having a wavelength sensitivity X nm/RIU (refractive index units) compared to the background refractive index, a receptacle for receiving a test sample, a light source capable of exciting the grating surface at a given bias angle chosen so that a change in the refractive index of a buffer or an analyte, results in an observed wavelength sensitivity of −X nm/RIU due to refraction, a spectrometer positioned to capture reflected light off the grating; and a computer controller, wherein the computer controller operates the light source, the receptacle or the spectrometer in order to perform a surface plasmon resonance sensor measurement of the test sample.

In another embodiment, there is described a method of plasmon resonance analysis, the method involving determining, via a processor, a plurality of wavelengths of a reference feature and a plasmon resonance feature by performing a curve fitting operation; subtracting, via the processor, an effect of a buffer refractive index on a plasmon resonance from an organic film effect; eliminating, via the processor, a background refractive index; and producing, via the processor, an organic film effect on the plasmon resonance, free of the background refractive index.

The system and methods as described herein may present several advantages over current systems in the way of increased stability, sensitivity, and accuracy.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a plot showing the plasmon resonances excited with a prism using a Kretschmann configuration of the prior art.

FIG. 2 illustrates a top view of an optical configuration for measurement of plasmon resonances on a gold coated grating according to an embodiment.

FIG. 3 illustrates a graph of a shift of resonant coupling angle, according to an embodiment.

FIG. 4 illustrates a graph of an organic film without refraction correction according to an embodiment.

FIG. 5 illustrates a plot of reflectance vs wavelength in accordance with an embodiment.

FIG. 6 illustrates a 41 degree AOI experiment in accordance with an embodiment.

FIG. 7 illustrates a 55 degree AOI experiment without Snell's law correction in accordance with an embodiment.

FIG. 8 illustrates a 55 degree AOI experiment with Snell's law correction in accordance with an embodiment.

FIG. 9 illustrates a graph of resonance wavelength versus time in accordance with an embodiment.

FIG. 10 illustrates a second order mode in accordance with an embodiment.

FIG. 11 illustrates a graph with a +1 diffraction order cutoff in accordance with an embodiment.

FIG. 12 illustrates a graph of reflection vs angle of incidence (Deg) in accordance with an embodiment.

FIG. 13 illustrates a gold grating as a sensor layer in accordance with an embodiment.

FIG. 14 illustrates a plot of TM polarization reflectance versus wavelength in accordance with an embodiment.

FIG. 15 illustrates a group of diffraction orders in accordance with an embodiment.

FIG. 16 illustrates a system for plasmon resonance sensing in accordance with an embodiment.

FIG. 17 illustrates a system for plasmon resonance sensing in accordance with an embodiment.

FIG. 18 illustrates a system for plasmon resonance sensing in accordance with an embodiment.

FIG. 19 illustrates a system for plasmon resonance sensing in accordance with an embodiment.

FIG. 20 illustrates a plot of efficiency versus wavelength in accordance with an embodiment.

FIG. 21 illustrates another plot of efficiency versus wavelength in accordance with an embodiment.

FIG. 22 illustrates a method of operation in accordance with an embodiment.

### DETAILED DESCRIPTION

The present disclosure is in the technical field of optical biomolecular sensors. More particularly, the present disclosure relates to the field of optical sensors using the surface plasmon resonance effect.

The present disclosure is also related to the technical field of photonics. More particularly, in the field of plasmon resonance-based sensing that may not be sensitive to refractive index changes in the buffer but sensitive to adsorbed biomolecules on the sensor.

Optical techniques used to identify and measure biomacromolecules such as proteins, glycosaminoglycans and nucleic acids may need fluorescent or enzymatic labels as well as a means of isolating or separating analytes. Label-free techniques such as surface plasmon resonance (“SPR”) separate analytes contained in complex mixtures through the use of specific capture ligands, such as antibodies bonded to a metallic surface in contact with a dielectric, and measure the presence of bound biomolecules by optically measuring the reflectance/scattering/transmittance off the surface. Several different modalities, such as electrochemical sensing, optical scattering spectroscopy and imaging, fluorescence sensing and imaging and optical absorption spectroscopy, are also used for the detection of biomolecules or analysis of samples containing biomolecules. Different devices are typically used to measure each modality, and the sample may need to be transferred between different devices, making in situ simultaneous measurements impossible. It would be beneficial to have all or some of the above modalities within a single device simultaneously during an experiment. The present disclosure presents apparatus, systems and methods to measure one or more modalities simultaneously. These measurements may be taken in real time or in situ. The present disclosure may generate otherwise not achievable data during a biomolecular binding experiment or other experiment that could involve cells, bacteria, biomolecules, electrochemically deposited polymers, fluorescent or plasmonic nanoparticles or other small, micro-, or nanostructures. The present disclosure may also offer improvement of sensitivity for the detection of biomolecules and biological structures in plasmon resonance-based sensing. The present disclosure may also achieve an SPR sensor that may be less sensitive to the refractive index of the buffer while still sensitive to the adsorbed biomolecules on the surface.

Light of a specific wavelength striking a metal/dielectric interface at a specific angle may support a rapidly decaying wave phenomenon (surface plasmon) under certain conditions, such as if there is a means of matching the momentum (K-vector) of the light with that of the loosely bound electrons at the metal/dielectric interface. When this resonance energy transfer occurs, the intensity of the light reflected from the metal surface may decrease. This resonance phenomenon may be quite sharp (on the order of a few Millidegrees) and the incident angle may be extremely sensitive to the refractive index at the surface of the metal substrate. The resonance coupling condition for the surface plasmon polariton may be affected by the adsorption of biomolecules. The resonance condition may be interrogated optically using a collimated or partially collimated beam. The resonance condition may exhibit itself as a dip in the reflected light spectrum. Disclosed herein, is an optical device that may be used along with an excitation fiber and a collection fiber to measure the plasmon resonance wavelength.

Typically, antibodies bound to a metal surface may be used to capture specific analyte molecules present in a complex sample mixture which shows over the metal surface. This highly specific immunochemical process results in specific analyte molecules being bound to well-identified regions of the metal substrate without the necessity of physical compartmentalization of the fluid. For each captured analyte, the magnitude of the change in the resonant angle may be proportional to the mass of analyte captured in each region. With appropriately designed accommodations, an SPR analyzer may be made to capture living cells (or viruses or bacteria) by surface antigens normally expressed on the surface of the cells. In this manner, specific cell types, distinguished by their surface antigens may be isolated and captured on a metal surface. Cells captured in an SPR analyzer in this manner can be activated by contact with suitable mitogens.

Capture antibodies for various cell secretions (cytokines) may be spotted on the surface in order to immobilize the secreted cytokines. Cytokines are relatively small molecules and the amount of a particular cytokine secreted by a single cell is typically too small to be detected by SPR resonance angle shifts. Conventional SPR systems may not possess enough sensitivity to detect certain molecules at concentrations that may be encountered in healthy blood serum or plasma.

In SPR biosensing, the adsorption of a targeted analyte by a surface bioreceptor may be measured by tracking the change in the conditions of the resonance coupling of incident light to the propagating surface plasmon wave (SPW). The existence of this surface plasmon wave is dictated by the electromagnetic (EM) properties of a metal, typically gold or silver, and a dielectric (sample-medium) interface. The resonance coupling appears as a dip in the reflectivity of the light spectrum, which is traditionally tracked by measuring the wavelength, the incident angle or the intensity of the reflected light. The coupling of the light to the SPW may use, for electromagnetic reasons, a high-index prism or a periodic grating surface. The sensitivity of the SPR lies in the strong electromagnetic enhancement of the SPW. Commercial SPR biosensors are generally capable of detecting 1 pg/mm2 (define?) of absorbed analytes. This sensitivity may depend on many parameters, particularly on surface functionalization. In comparing sensitivity between reported SPR biosensors, the sensitivity values may often be described independently of the surface functionalization chemistry or for a specific application. For a more relevant assessment, the sensitivity, where it is available, is typically expressed in terms of detectable refractive index unit (RIU) change. This value reflects the performance of the optical configuration, the measurement approach or the data analysis algorithm. Commercial systems generally report with sensitivity in the range of 1×10⁻⁵ to 1×10⁻⁶ RIU. A challenge in the SPR biosensor development lies not primarily in the integration of the various components of the biosensor (sampling handling, control electronics, etc.) but on providing robust integrated SPR biosensors that may have better sensitive (<pg/mm2) than their current counterparts. Beyond the requirement for high sensitivity, in particular for the detection of small biomolecules, low cost of production, compact design, reusability and increased functionality (multiple analyte detection, temperature control, etc.) are as well sought.

The surface plasmon resonance is significantly affected by a thin analyte layer on the metal layer and as well as by the bulk refractive index changes. In the absence of an analyte layer the SPR angle (θ_{SPR}) is determined by:

$${θ}_{SPR} = {sin}^{- 1} Re [ \begin{matrix}{k}_{SP} \\ {k}_{0} {n}_{p}\end{matrix} ] \qquad ( Eq . 2 , NOTE : Eq . 1 intentionally omitted )$$

where k₀=2πλ is the free space wavevector magnitude, and k_{SP} is the surface plasmon polariton (SPP) wavevector magnitude given as:

$${k}_{SP} = {k}_{0} \sqrt{\frac{{∈}_{d} {∈}_{m}}{{∈}_{d} + {∈}_{m}}} \qquad ( Eq . 3 )$$

where ∈_{d} and ∈ₘ are the complex dielectric constants of the bulk and the metal supporting the SPP, respectively. The change in the SPP wavevector upon deposition of an analyte layer of thickness h is given by:

$$Δ {k}_{SP} ≅ Re [ \frac{{k}_{SP}^{3}}{{K}_{0}^{2} {n}_{d}^{3}} Δ {n}_{or g} ( 1 - exp ( - 2 {γ}_{d} h ) ) ] \qquad ( Eq . 4 )$$

where Δn_{org}=n_{org}−n_{d} is the refractive index contrast between the organic layer index and the bulk (analyte buffer) and γ_{d}=ik₀ ϵ_{d}/√(ϵ_{d}+ϵₘ). The change in the SPR angle upon changes in the bulk refractive index (Δn_{d}) and the analyte layer thickness of h is then determined as:

$$Δ {θ}_{SPR} = \frac{1}{{k}_{0} {n}_{p} cos {θ}_{SPR}} Re [ \frac{{k}_{SP}^{3}}{{k}_{0}^{2} {n}_{d}^{3}} Δ {n}_{d} + \frac{2 {γ}_{d} {k}_{SP}^{3}}{{k}_{0}^{2} {n}_{d}^{3}} {Δ}_{nor g} h ] \qquad ( Eq . 5 )$$

The approximation remains valid for h<<1/γ_{d}˜233 nm for a wavelength of 700 nm on Au/water interface. Equation 5 captures the shift in θ_{SPR} with accumulation of an analyte layer or varying bulk refractive index close to the actual values calculated using the transfer matrix method (TMM) especially for the longer wavelengths resulting in larger penetration depths (1/γ_{d}). One of the techniques for satisfying the energy and momentum matching condition for the plasmon resonance is to employ a grating. The presence of a metal planar surface that is patterned with a shallow grating of grooves with some periodicity modifies Equation 3 as follows:

$${k}_{SP} = m \frac{2 π}{∧} + {k}_{0 , in Plane} \qquad ( Eq . 6 )$$

where m is an integer denoting the diffraction order, k_{0,in Plane}=k₀ [symbol] [symbol] Θ_R [symbol] is the in-plane vector of the incident light and A is the grating period. And thus a plane wave approaching the surface can resonantly couple to the plasmonic excitation at a particular angle of incidence defined by:

$${θ}_{R} = {sin}^{- 1} [ ( Re \sqrt{\frac{{∈}_{m}}{{∈}_{m} + {∈}_{d}}} ) - \frac{m λ}{∧ \sqrt{{∈}_{d}}} ] \qquad ( Eq . 7 )$$

If the measurement is performed inside a fluidic channel, a cuvette or a well plate with a transparent top or bottom window, the incidence angle Θ1 inside the fluidic chamber will be different than that in air due to refraction and may be corrected according to Snell's law. An apparatus designed to employ this correction provides a part of the present disclosure.

For conventional SPR systems working in the visible or near infrared part of the spectrum (400 nm-1800 nm), the SPR angle or wavelength shift upon adsorption is dependent on the optical thickness Δn_{org} h of the adsorbed species, and typically refractive indices of biomolecules and biomolecular structures are near n=1.47, and without strong absorption.

The sensitivity of the grating coupled SPR configuration to the bulk and the analyte layer can be expressed as:

$${Δθ}_{GCSPR} = \frac{1}{{k}_{0} {n}_{d} cos {θ}_{GCSPR}} e [ \frac{{k}_{SP}^{3}}{{k}_{0}^{2} {n}_{d}^{3}} Δ {n}_{d} + \frac{2 {γ}_{d} {k}_{SP}^{3}}{{k}_{0}^{2} {n}_{d}^{3}} Δ {n}_{or g} h ] \qquad ( Eq . 8 )$$

where the resonant coupling angle

$${θ}_{GCSPR} = {sin}^{- 1} e [ \frac{{k}_{SP} - \frac{2 π m}{{∧}_{G}}}{{k}_{0} {n}_{d}} ] \qquad ( Eq . 9 )$$

where m is an integer defining the order, and ∧_{G} is the granting period. For an incident TM wave with an angle of incidence of θᵢ the angle of scattering into order N is given by:

$${θ}_{N} = {sin}^{- 1} [ sin {θ}_{i} + \frac{N λ}{{∧}_{G} {n}_{d}} ] \qquad ( Eq . 10 )$$

When the grating period is chosen small enough that other orders are not allowed, there is a cut-off angle for scattering into the order N=−1, given the condition:

$$sin {θ}_{i} - \frac{λ}{{∧}_{G} {n}_{d}} > - 1 \qquad ( Eq . 11 )$$

Or the cut-off angle is:

$${θ}_{cut - off} = {sin}^{- 1} [ \frac{λ}{{∧}_{G} {n}_{d}} - 1 ] \qquad ( Eq . 12 )$$

Equations 8-12 point out that this cut-off angle may be independent of k_{SP} and depends on the bulk refractive index. Therefore, this angle may serve as a measurement for the bulk refractive index changes independent of the absorbed molecular layers. Note that, the mechanism leading to the feature may be completely different from the TIR reference feature described herein.

The reference features for the grating configuration is also visible for the reflectance spectra gathered using wavelength interrogation. The advantage of the wavelength interrogation is the presence of the +1 and −1 SPP resonances under the right conditions. The shifts of the +1 and −1 SPP resonances depend on the bulk refractive index and organic film thickness in a linearly independent fashion for organic layer thicknesses much smaller than the plasmon penetration depth. The differences in the plasmon penetration depth results in significantly varying sensitivities at two wavelengths. Simultaneous measurement of the shifts for the two resonances, thus provide another method to account for the bulk refractive index changes. For the case of a Ag grating with 555 nm period in a buffer with refractive index of n=1.333, at an angle of incidence of 20°, two resonances occur near 550 nm and 1000 nm. The penetration depths of the field into the dielectric are similar for both Ag and Au. It should be noted that a thin Au layer on a Ag layer does not significantly degrade the quality factor of the resonances and has the practical benefit of using Au chemistry for molecular binding, as well as protecting the Ag layer from degradation. To a first order approximation, where the organic film thickness is small compared to the field penetration depth, the wavelength shifts in the +1 and −1 resonances (S₊ and S₋) are given by:

S₊=α₊Δn_{d}+β₊Δn_{or g}h (Eq. 13A)

S₋=α₋Δn_{d}+β₋Δn_{or g}h (Eq. 13B)

Where α₊ and β₊ are constants depending on the grating period, the bulk refractive index, the dielectric constant of metal and the angle of incidence. If the shifts S₊ and S₋ are measured in a wavelength interrogation measurement with fixed incidence angle, Δn_{d} and the product Δn_{or g}h can be solved as:

$$Δ {n}_{d} = {[ \frac{{α}_{+}}{{β}_{+}} - \frac{{α}_{-}}{{β}_{-}} ]}^{- 1} x ( \frac{{S}_{+}}{{β}_{+}} - \frac{{S}_{-}}{{β}_{-}} ) \qquad ( Eq . 14 A )$$

$$Δ {n}_{or g} h = {[ \frac{{β}_{+}}{{α}_{+}} - \frac{{β}_{-}}{{α}_{-}} ]}^{- 1} \times ( \frac{{S}_{+}}{{α}_{+}} - \frac{{S}_{-}}{{α}_{-}} ) \qquad ( Eq . 14 B )$$

The simulation results show that, the high wavelength resonance is more sensitive to the changes in the bulk refractive index compared to the low wavelength resonance. The trend is reversed for the detection of the organic layer. The α and β parameters in equations 13 and 14 determine how the resonance shifts depend on the bulk refractive index changes and the analyte thickness. Table 1 tabulates some of the simulation results for Ag gratings in water for several different parameters. Such results are needed to design the grating and measurement setup, as the α and β parameters can't be expressed in closed form due to the complex dependence of practical dielectric functions of metals on frequency and can be calculated accurately using full-wave simulations. However, once the sensitivities are known, simultaneous detection of any bulk refractive index change and accumulation of an organic layer on a grating-coupled SPR surface is possible using the double resonances that are present in the wavelength interrogation.

TABLE 1
λ₋, λ₊, α, β values for Ag gratings with shown
periods and angles of incidence (AIO) in buffer (n_{d} = 1.333). Grating depths are 20 nm.

| Period | AOI | | | β₋ (nm/5 nm | α₋ | β₊ (nm/5 nm | α₊ |
|---|---|---|---|---|---|---|---|
| (nm) | (°) | λ₋ (nm) | λ₊ (nm) | thick film) | (nm/RIU) | thick film) | (nm/RIU) |
| 300 | 10 | 428.1996 | 515.1486 | 8.4722 | 238.94 | 5.9395 | 359.83 |
| 350 | 10 | 463.9021 | 583.9758 | 8.2329 | 294.50 | 5.1005 | 425.67 |
| 400 | 10 | 505.5116 | 655.9164 | 7.5027 | 336.50 | 4.3478 | 480.76 |
| 450 | 10 | 550.8627 | 729.7558 | 7.0183 | 389.11 | 3.8246 | 540.65 |
| 500 | 10 | 598.9831 | 804.6071 | 6.4999 | 435.92 | 3.3837 | 597.15 |
| 550 | 10 | 648.3765 | 880.2435 | 5.8395 | 469.43 | 3.0465 | 657.30 |
| 600 | 10 | 698.8837 | 956.6600 | 5.4374 | 516.52 | 2.7867 | 716.35 |
| 300 | 20 | 403.9830 | 570.1604 | 9.1825 | 225.80 | 4.7102 | 414.71 |
| 350 | 20 | 425.2370 | 652.8803 | 9.0240 | 226.37 | 3.8917 | 478.87 |
| 400 | 20 | 451.2106 | 737.8618 | 9.0750 | 267.33 | 3.3454 | 547.71 |
| 450 | 20 | 481.4497 | 824.0079 | 9.0600 | 315.88 | 2.9100 | 613.87 |
| 500 | 20 | 514.3970 | 911.1494 | 8.5556 | 346.80 | 2.5962 | 682.48 |
| 400 | 30 | 416.6176 | 817.0545 | 9.4672 | 195.19 | 2.6432 | 608.01 |
| 450 | 30 | 434.1519 | 914.6841 | 10.0757 | 242.95 | 2.3219 | 685.10 |

The background refractive index changes in and SPR experiment complicates the extraction of data that depends on biomolecular binding. For this purpose, in the present design, a novel approach is taken, where the SPR is used in the grating coupled configuration and the metal coated grating is inserted into a square or rectangular cuvette that houses the sample. The geometry of the SPR measurement is done in the wavelength interrogation scheme and the incidence angle is chosen such that the change in the angle of refraction of light due to the refractive index changes of the buffer compensates the SPR shift wavelength. The design results in an SPR sensor that is not sensitive to the buffer refractive index while maintaining sensitivity to biomolecular surface adsorption.

In the present design, the reflection from the surface is measured sequentially for the transverse electric (TE) and magnetic (TM) polarizations, through the use of electronically controlled polarizers. The polarization control allows one to measure a reference curve using the TE reflection for each data point in the measurement. This continuous reference data collection enables elimination of drifts in the light source intensity. Elimination of drifts through such multiple-polarization measurements allows long term stability of the instrument for surface plasmon resonance measurements. The polarizers can be implemented using various mechanisms, such as the mechanical rotation of a polarizer or through voltage application to a liquid crystal cell.

All illustrations of the drawings are for the purpose of describing selected versions of the present disclosure and are not intended to limit the scope of the present description.

The present disclosure provides an optical measurement configuration and methods for obtaining SPR measurements of biomolecular adsorption that is insensitive to buffer refractive index or providing separate channels of measuring the background refractive index and using it as a reference.

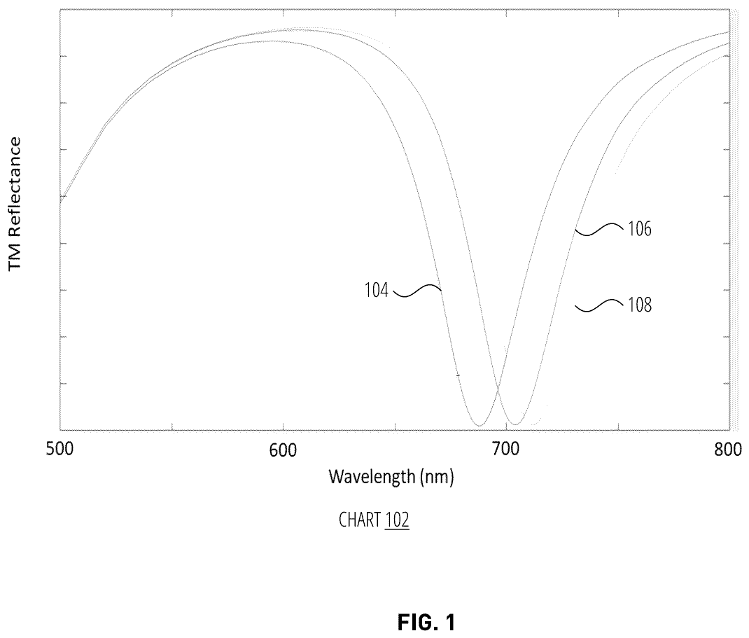

FIG. 1 is a chart 102 using the Kretschmann configuration, light may be projected through a prism, and the set up may use an index 1.5 with 50 nm gold (Au) coating. The curves on the chart 102 show values for the Kretschmann configuration immersed in deionized water (DI) with a refractive index of about n=1.330 and a wavelength of 688 nm 104. Another curve shows the configuration immersed in phosphate buffered saline (PBS) solution of refractive index n=1.337 and with a 5 nm thick dielectric film and a reflectance wavelength of about 704 nm 106.

A difficulty with background refractive index of a buffer using a Kretschmann type SPR measurement is exemplified. In a conventional SPR measurement that uses prism coupling, the shift of the SPR peak is sensitive both to the buffer refractive index and molecular adsorption. A plot of Transverse Magnetic (TM) polarized reflectance at a 73 degree angle of incidence is given, showing the plasmon resonances excited in Kretschmann geometry with a prism of index 1.5 with 50 nm Au coating and immersed in deionized water (DI) of refractive index n=1.330, and separately in phosphate buffered saline (PBS) solution of refractive index n=1.337 and with a 5 nm thick dielectric film of refractive index n=1.5 (this value does not appear on the chart of FIG. 1??) representing a typical molecular monolayer film. Here the background refractive index related to wavelength shift is large, and because the wavelength shifts due to background index and film thickness are not separately measured from the reflection plot.

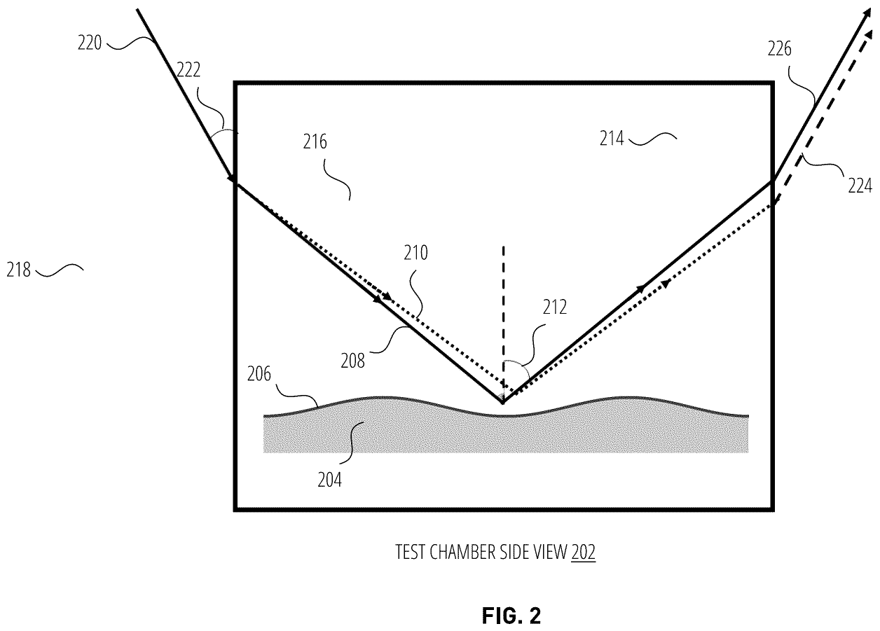

FIG. 2 shows a diagram of a test chamber side view 202 of the optical configuration for measurement of plasmon resonances on a gold coated grating where the measurement chamber may have a planar face for the entry and exit of light, so as to reduce the distortion effect of a rounded container. In some embodiments, the test sample may be contained in a square or rectangular container and collimated white light enters the chamber from one side at a specific angle and exits at the same angle after reflecting from the planar grating surface. The rectangular or square chamber may be filled with a buffer solution and a sample of biomolecules that may bind onto the gold surface.

In an embodiment, the test chamber side view 202 for measurement of plasmon resonances on a gold coated grating may have a gold grating 204 with a molecular film 206. An excitation light 220 may enter the test chamber with an external bias angle 222. The light may refract on contact with the test chamber wall, producing refracted beams 216 of light. A first beam may have a value of n, and a second beam may have a value of n+Δn. The refracted beams 216 strike the thin film stack and reflect off the molecular film 206, the gold grating 204 and other layers of the thin film stack (not shown). The reflected light has one ore more bias angle AOI (angle of incidence) and continue on to the next transparent wall of the test chamber where the light is becomes refracted and reflected light 224, 226. The test chamber may contain a buffer 214 solution, which may also effect the light passing through it.

In some embodiments, the measurement chamber may be square or rectangular in cross-section. In an embodiment, collimated white light may pass through the chamber wall from one side at a specific angle and exits at the same angle after reflecting from the planar grating surface. The rectangular or square chamber may be filled with a buffer solution such as Phosphate Buffered Saline (PBS), water (H2O), Dimethylsulfoxide (DMSO) or other suitable solutions. Biomolecules may be suspended, dispersed or precipitated in the buffer solution, such that the biomolecules may come into contact with the gold surface, and interact with the surface. In an embodiment, the excitation light may be white in spectrum. The grating may display plasmonic resonance at wavelengths that matches the resonant coupling condition as described by Equations 6 and 7. The wavelength of the resonance may depend on both the buffer refractive index and the adsorbed molecular film thickness as described by Equations 4 and 5. Without Snell's law in effect, the wavelength of the resonance would shift upon a change in the buffer refractive index due to changes in the plasmon wave vector. When there may be a change in the buffer refractive index, a change in the bias angle occurs due to refraction, resulting in a change in observed plasmon resonance wavelength. In the various embodiments presented, flat edge test sample containers are used through out. Curved or other shapes of test sample containers may be used so long as the proper calculations are made for refraction and reflection within the container walls.

In various embodiments, the two shifts may be made opposite and equal in magnitude, so that the measurement becomes independent of the buffer refractive index, and more sensitive to the surface adsorbed molecules. The parallel sidewalls of the chamber reduce the calculation complexity to provide that the exit beam conserves the same angle at the entry side. It may be apparent that non flat side walls (such as rounded or even tinted) may be adapted for by using various filters on the light, and increased calculation complexity in signal processing, all of which are a part of the present disclosure. Sample containers may include cuvettes, multi-well plates, petri dishes, test tubes, sample vials and so on. Sample containers may be made of any optically transparent material, such as plastic or glass.

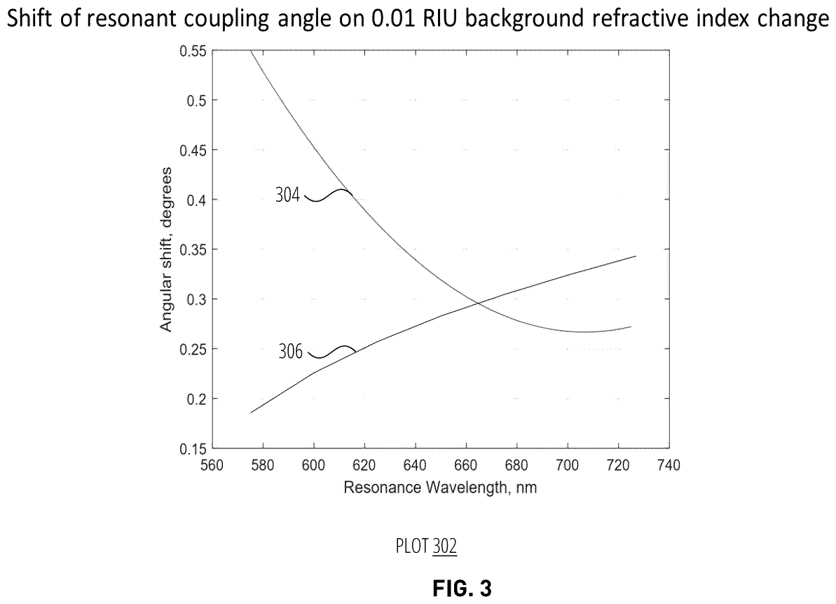

FIG. 3 shows a plot 302 of the angular shifts of the internal bias angle due to grating coupling to the plasmon resonance and refraction at the corresponding bias angle upon a 0.01 refractive index change (RIU) from water (n=1.330) for a grating of period of 2 micrometers. When the refraction 306 and grating coupled resonance shift 304 are matched around 670 nm, the SPR measurement becomes insensitive to the buffer refractive index perturbations. This bias condition is referred to as the background-compensated bias condition, or BCBC. Refractive index units (n), are be the change in the refractive index due to the binding of the biomolecule on the gold grating surface.

FIG. 3 illustrates a calculated plot of the resonance angle shift upon a change of the buffer refractive index from 1.330 to 1.337 as a function of resonance wavelength for a 2000 nm period grating biased at 56 degrees of angle of incidence. The angular shift due to refraction is also shown. In an embodiment, the shifts due to the two effects match around 670 nm wavelength. This bias condition may be insensitive to buffer refractive index and more sensitive to molecular adsorption. Such a condition may be achieved for other grating periods, bias angles and resonance wavelengths.

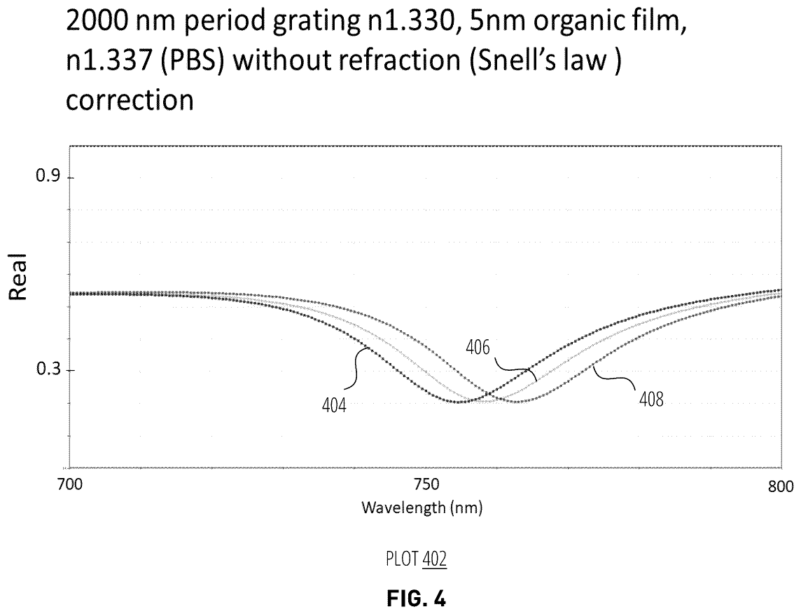

FIG. 4 illustrates a plot 402 reflectance (labeled “real” on the figure) of the plasmon resonances for a 2 micrometer period gold coated grating as a function of wavelength when the bias angle (external to sample container at 41 degrees) may be chosen to resonate at around 750 nm for a buffer 1 404 (DI water), a buffer 2 406 (PBS buffer) and a 5 nm thick biofilm 408. The refraction due to changes in the buffer refractive index shift is not taken into account.

FIG. 4, illustrates a calculation of the resonance wavelength of the 2000 nm period grating as shown for 49-degree bias angle, in DI water, PBS (n=1.337) and in DI water with an organic film. Without the refraction correction, a positive shift is observed in SPR wavelength both for buffer and organic film.

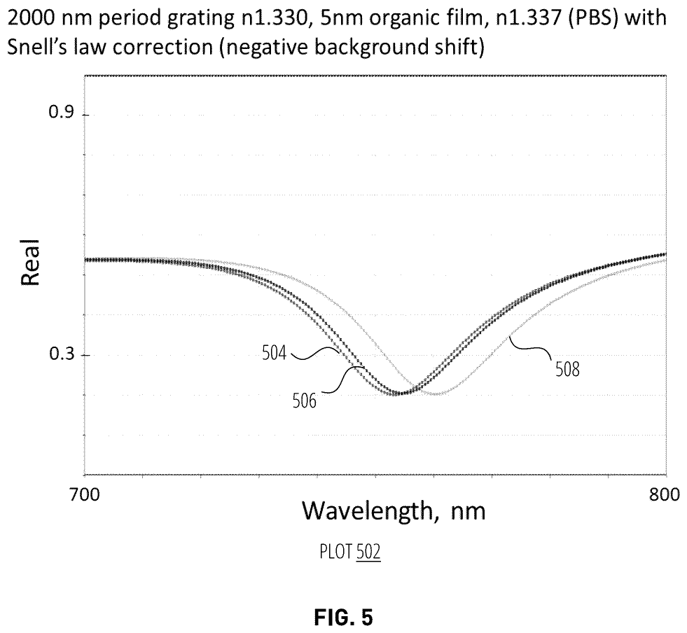

FIG. 5 illustrates a calculated plot 502 of the plasmon resonances for a 2 micrometer period gold coated grating reflectance (labeled “real on the figure”) as a function of wavelength when the bias angle (external to a sample container at 41 degrees) may be chosen to resonate at around 750 nm for DI buffer, PBS buffer and 5 nm thick organic film. The refraction due to changes in the buffer refractive index shift may be taken into account, resulting in a negative wavelength shift of the resonance when buffer refractive index increases.

The plot 502 shows a calculation of the resonance wavelength of the 2000 nm period grating for am embodiment using a 49-degree bias angle, in buffer 1 504 (DI water n=1.330), buffer 2 506 (PBS (n=1.337)) and in DI water with a 5 nm biofilm 508. With the refraction correction, a positive shift is observed in SPR wavelength for organic film, but a negative shift for the increase in buffer refractive index.

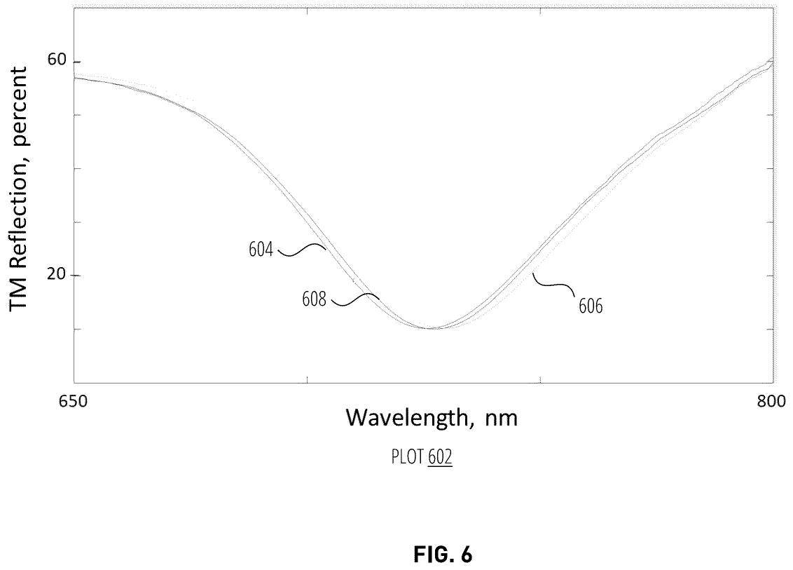

FIG. 6 illustrates an experimentally measured plot 602 of the plasmon resonances according to an embodiment. The plot 602 shows a 41 degree AOI experiment using a 2000 nm period gold coated grating as a function of wavelength when the bias angle (external to sample container at 41 degrees) is chosen to resonate at around 750 nm for DI water 608 buffer, PBS 604 buffer and 5 nm thick PBS+BSA 606 organic film (Bovine Serum Albumin, BSA). The refraction due to changes in the buffer refractive index shift is taken into account, resulting in a negative wavelength shift of the resonance when buffer refractive index increases, confirming predictions of FIG. 5.

The plot 602 shows a measurement of the resonance wavelength of the 2000 nm period grating is shown for 41 degree bias angle, in DI water, PBS (n=1.337) and in DI water with an organic film (BSA). A positive shift may be observed in SPR wavelength for organic film, but a negative shift for the increase in buffer refractive index, confirming the validity of the calculation shown in FIG. 6 (??).

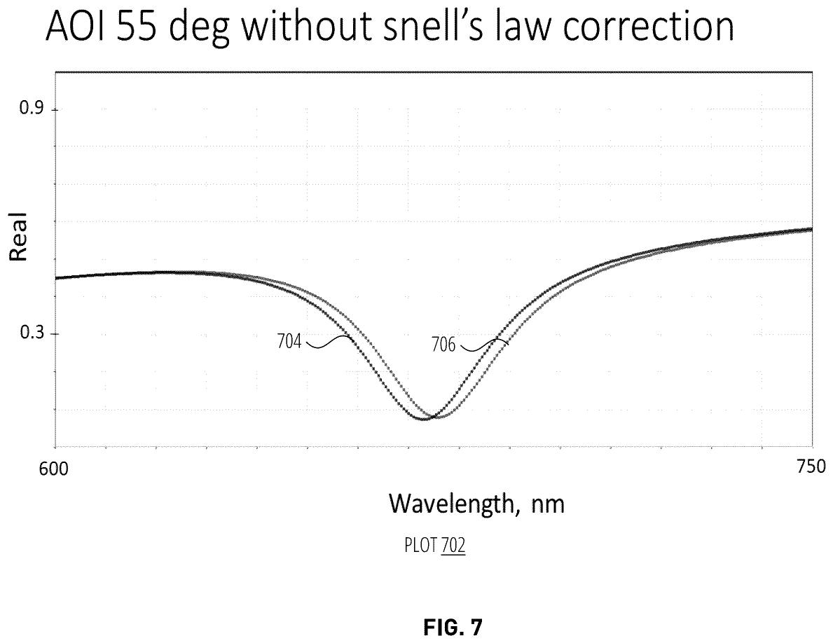

FIG. 7 illustrates a calculated plot 702 of the plasmon resonances according to an embodiment. The embodiment provides for a 2000 nm period gold coated grating reflectance (labeled as “real” on the figure) as a function of excitation wavelength when the bias angle (internal to sample container at 55 degrees to grating normal) is chosen to resonate at around 675 nm for DI water, and PBS buffer. The refraction due to changes in the buffer refractive index shift is not taken into account, resulting in a positive wavelength shift when the buffer refractive index (n) increases from n=1.330 704 to n=1.337 706.

The calculation of the resonance wavelength of the 2000 nm period grating is shown for 55 Degree bias angle, in DI water (n=1.330), and PBS (n=1.337). Without the refraction correction, a positive shift may be observed in SPR wavelength for the increase in buffer refractive index.

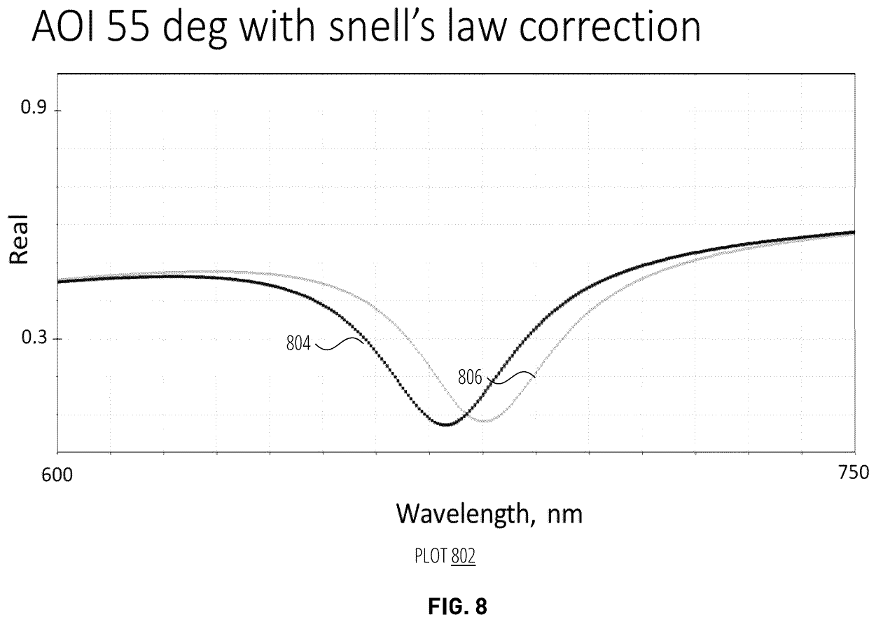

FIG. 8 illustrates a calculated plot 802 of the plasmon resonances according to an embodiment. The embodiment provides for a 2000 nm period gold coated grating reflectance (labeled “real” on the figure) as a function of wavelength when the bias angle (internal to sample container at 55 degrees to grating normal) is chosen to resonate at around 675 nm for DI water and PBS buffer and 5 nm thick organic film. The refraction due to changes in the buffer refractive index shift is taken into account, resulting in a zero-wavelength shift when the buffer refractive index 804 increases from 1.330 to 1.337. Upon adsorption of a 5 nm thick organic film, the resonance wavelength may be shifted towards higher wavelengths at about 1 nm per 1 nm thickness of adsorbed molecules. The biofilm refractive index 806 has a value of n=1.5.

FIG. 8 shows a calculation of the resonance wavelength of the 2000 nm period grating for a 55 degree bias angle, in DI water and PBS (n=1.337) and with 5 nm thick organic film in DI water. In an embodiment, the refraction correction may be a positive shift that may be observed in SPR wavelength for an organic film, but no observable shift may be present for the increase in buffer refractive index. This plot demonstrates the background insensitive nature of the measurement configuration according to an embodiment.

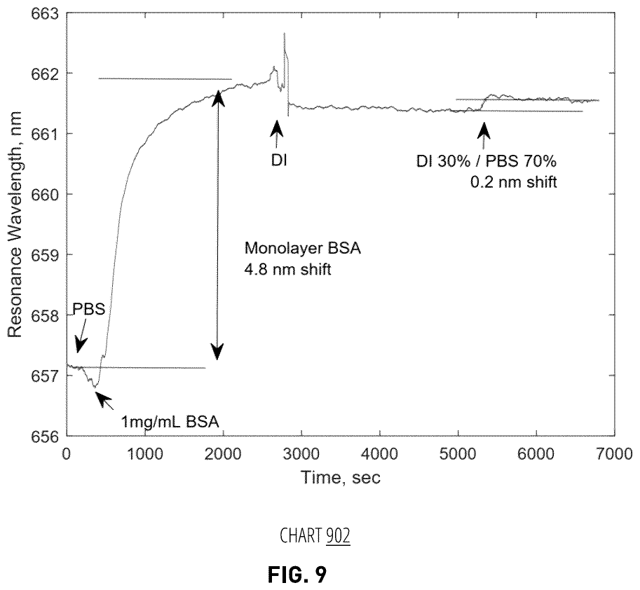

FIG. 9 illustrates an experimentally measured plot of the plasmon resonances according to an embodiment. The embodiment provides for a 2 micrometer period gold coated grating as a function of time when the bias angle (internal to cuvette at 55 degrees to grating normal) is chosen to resonate at around 660 nm for PBS buffer and 5 nm thick monolayer organic film (BSA) deposition. At the end of absorption, the buffer may be changed to DI water, and the later background refractive index may be changed by adding PBS into the sample container, resulting in a 0.2 nm positive wavelength shift, demonstrating the predictions of an embodiment as shown in FIG. 8.

The embodiment illustrated in FIG. 9, provides an experimentally measured plot of the plasmon resonances for a 2000 nm period gold coated grating as a function of time when the bias angle (internal to sample container at 55 degrees to grating normal) is chosen to resonate at around 660 nm for PBS buffer and 5 nm thick monolayer organic film (BSA) deposition. At the end of absorption, the buffer may be changed to DI water, and the later background refractive index may be changed by adding PBS into the cuvette, resulting in a 0.2 nm positive wavelength shift between the two buffers, demonstrating the predictions of FIG. 8. The very small but non-zero residual shift may be attributed to imperfections of the measurement setup and bias angle.

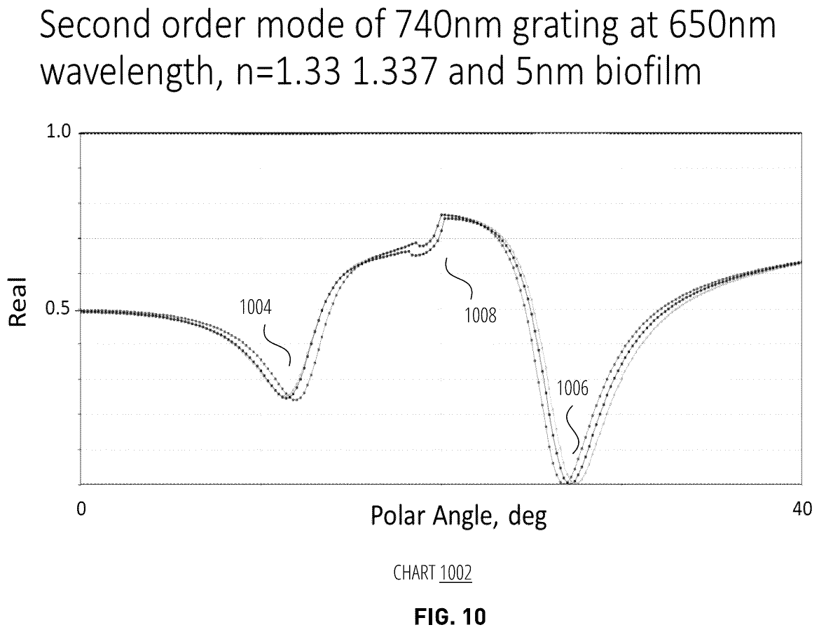

FIG. 10 illustrates a chart 1002 of the reflection off the grating showing plasmon resonances according to an embodiment. In an embodiment, the reflection off the gradient for a 0.74 micrometer period gold coated grating is illustrated showing reflectance (labeled as “real” on the figure) as a function of incidence angle (internal to the sample container, with respect to grating normal) at 650 nm for DI, PBS buffer and 5 nm thick monolayer organic film deposition. There may be two plasmon resonances with opposite angular shifts, corresponding to +1 and +2 order grating coupling to the plasmon mode. Additionally, a step-like feature appears around 20 degrees due to cut-off of the +1 diffraction order cut-off 1008 of the grating. This feature may not dependent on organic film thickness but may depend on buffer refractive index and may be used as a reference in determining the organic film thickness when the buffer refractive index changes.

The embodiment provides an alternative approach of eliminating the effect of background refractive index. A calculated plot of the reflection off the grating shows the plasmon resonances for a 740 nm period gold coated grating as a function of the incidence angle (internal to the sample container, with respect to grating normal) at 650 nm for DI water and PBS buffer and 5 nm thick monolayer organic film deposition. There may be two plasmon resonances with opposite angular shifts, corresponding to +1 and +2 order grating coupling to the plasmon mode. Additionally, a step-like feature appears around 20 degrees due to cut-off of the +1 diffracted order of the grating. This feature may not be dependent on organic film thickness, but may depend on the buffer refractive index and may be used as a reference in determining the organic film thickness when the buffer refractive index changes.

The order is based on periodicity (sp?), 0 is the main angle of reflection, then −1 and +1 are the first orders 1006, and −2 and +2 are the second orders 1004, and so on. The +1 and +2 are the opposite angle reflections (same order of magnitude but in a different direction).

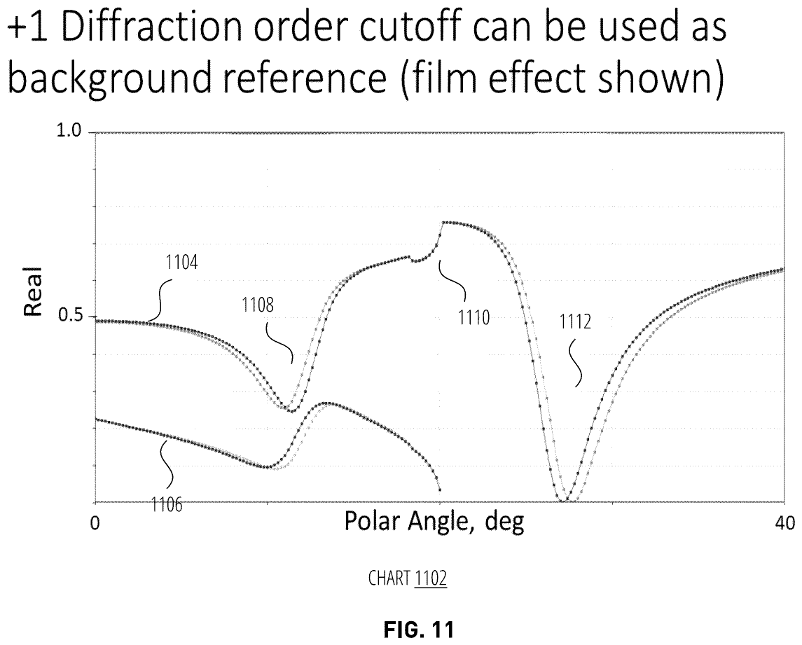

FIG. 11 illustrates a calculated chart 1102 of the reflection off the grating showing plasmon resonances according to an embodiment. In an embodiment, a 0.74 micrometer period gold coated grating is shown reflectance (labeled “real” on the figure) as a function of incidence angle (internal to a sample container, with respect to grating normal) at 650 nm for PBS buffer and 5 nm thick monolayer organic film. There may be two plasmon resonances with opposite angular shifts, corresponding to +1 and +2 order grating coupling to the plasmon mode. Additionally, a step-like feature may appear around 20 degrees due to cut-off of the +1 diffracted order of the grating. This feature may not depend on organic film thickness, but may depend on buffer refractive index and may be used as a reference in determining the organic film thickness when the buffer refractive index changes.

In an embodiment, the chart 1102 illustrates a 0th order efficiency 1104 with a dip at the +2 plasmon mode couplings 1108. An increase in diffraction is seen at the +1 diffraction order cut-off 1110. Then a drop in diffraction value is seen at the 1st+1st plasmon mode coupling 1112. The efficiency of the +1st order diffraction efficiency 1106 of the grating is included in the plot to show the relation between diffraction and the step-like reference feature in a 0th order reflection off the grating.

The embodiment shows a plot of the plasmonic resonance and the efficiency of the diffracted order for the grating coupled configuration given in FIG. 10 when the grating is immersed in DI water, with and without an organic film.

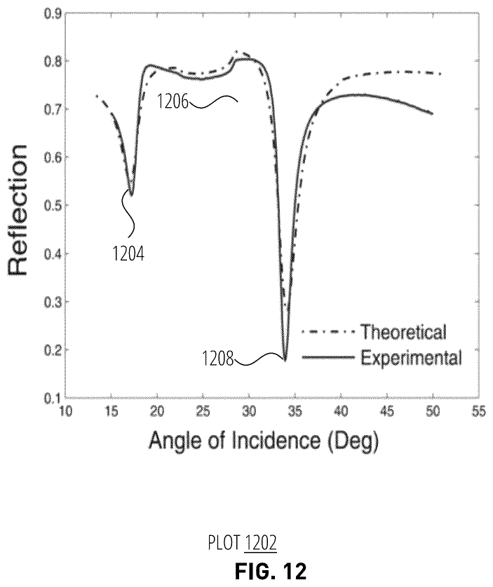

FIG. 12 illustrates a measured and calculated plot 1202 of the reflection off the grating showing plasmon resonances according to an embodiment. In an embodiment, reflectance off a 0.74 micrometer period gold coated grating is shown as a function of incidence angle (internal to a sample container, with respect to grating normal) at 650 nm for DI buffer. In an embodiment, there may be a +2 order plasmon resonance 1204 at around 16 degrees, and a +1 order plasmon resonance 1208 at around 34 degrees. There may be two plasmon resonances with opposite angular shifts, corresponding to +1 and +2 order grating coupling to the plasmon mode. Additionally, a step-like background reference feature 1206 may appear around 27 degrees (external to the sample chamber) due to cut-off of the +1 diffracted order of the grating. This feature may not depend on organic film thickness but may depend on the buffer refractive index and may be used as a reference in determining the actual organic film thickness when the buffer refractive index changes. The efficiency of the +1 diffracted order of the grating is included in the plot to show the relation between diffraction and the step-like reference feature in 0th order reflection off the grating.

The plot illustrates an experimental plot of TM reflection from a 740 nm period gold coated grating in the configuration in FIGS. 10 and 11 are shown. The reference feature may be observed in the experimental data as predicted by theory.

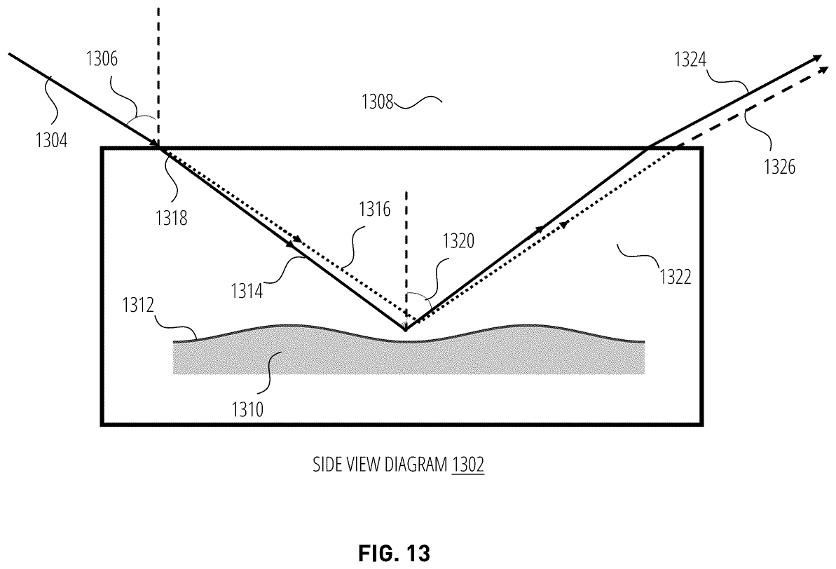

FIG. 13 is a side view diagram 1302 showing a measurement set up used for FIGS. 10, 11, and 12. In an embodiment, the side view diagram 1302 illustrates an excitation light 1304 entering a test container with an external bias angle 1306. The excitation light 1304 undergoes refraction 1318, producing at least an n 1316 beam and a n+Δn beam 1314. The pair of refracted light beams reflect off the thin film stack having a gold grating 1310 and a molecular film 1312. The reflected light has one or more bias angle, AOIs 1320 and exits from the test container as reflected and refracted light 1324, 1326. The test container may contain a buffer 1322 solution, and the exterior may be an environment of air 1308.

In an embodiment, the optical configuration for the measurements shown in FIG. 12 is shown. The excitation wavelength is 650 nm for the data in FIG. 12. A white-light source may be used to measure plasmonic resonances for a given fixed angle of incidence in this embodiment.

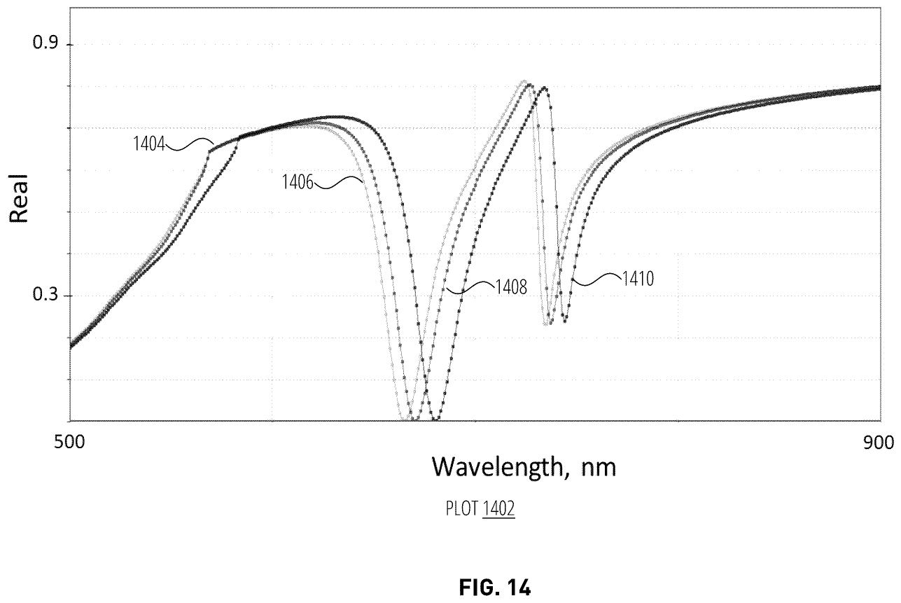

FIG. 14 illustrates a calculated plot 1402 of the reflection off the grating showing plasmon resonances according to an embodiment. In an embodiment, light reflectance (labeled “real” on the figure) off a 0.74 micrometer period gold coated grating is shown as a function of a wavelength for 25 degree incidence angle (internal to the sample container, with respect to grating normal) for n=1.350 refractive index buffer and 5 nm thick monolayer organic film 1410. There may be two plasmon resonances with opposite angular shifts, corresponding to +1 and +2 order grating coupling to the plasmon mode. Additionally, a background index 1404 dependent reference feature, or step-like feature may appear around 560 nm due to a cut-off of the diffracted order of the grating. This feature may not depend on organic film thickness but may depend on buffer refractive index and may be used as a reference in determining the organic film thickness when the buffer refractive index changes.

In this embodiment, a calculation of the reflectance as a function of wavelength is shown for the optical measurement configuration of FIG. 13, for a bias angle of 25 degrees on a 740 nm period grating immersed in DI 1406 water, PBS and DI water with 5 nm thick film (DI n=1.330+5 nm film 1408). The primary plasmonic resonance may occur around 670 nm, and the reference feature may occur at around 570 nm. The wavelengths may be adequate for measurement with a visible light spectrometer and using a white LED light as the excitation source, allowing a compact measurement setup that may be miniaturized.

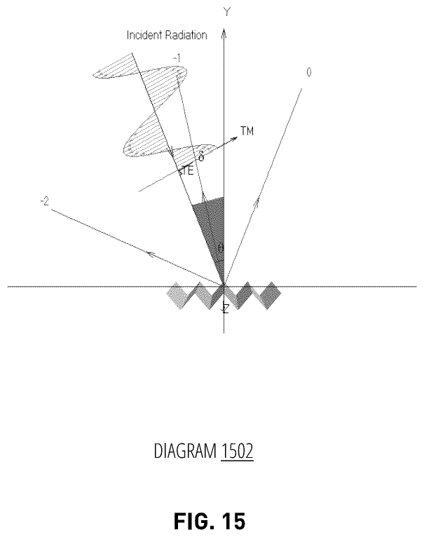

FIG. 15 illustrates a diagram 1502 of the diffracted orders of a 740 nm period grating in DI water at an angle of incidence of 25 degrees according to an embodiment. The diffracted orders 0, −1 and −2 are shown schematically, when a 740 nm period grating is excited at 25-degree bias angle. The −1st order diffracts at a negative angle. By placing a fiber optic cable with a collimator, the diffracted light can be collected. The dominant wavelength of the diffracted light may be used as a background refractive index measurement, since it may depend on the buffer refractive index and not on the presence of a biomolecular film on the grating.

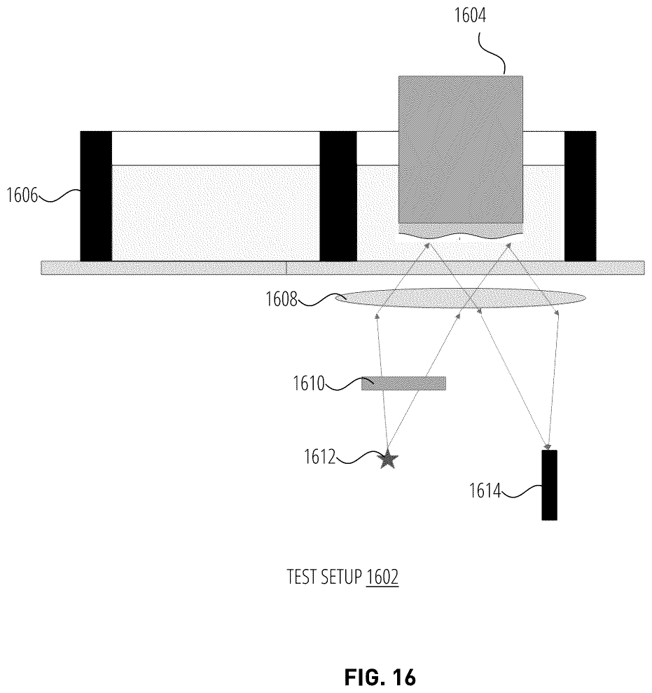

FIG. 16 illustrates a cross section view of a test setup 1602 according to one aspect of the present disclosure. In an embodiment, the thin film stack may be mounted to a carrier 1604, and inverted so the thin film stack is pointed downward, toward a test solution. The test solution may be contained by a flat surface test chamber 1606 to reduce the interference of light entering and exiting the test container. A light source 1612 projects lights through a polarizer 1610. The light may then pass through a lens 1608, the wall of the test container, and reflect off the surface of the thin film stack. The reflected light may pass through the lens again, and be detected with a spectrometer.

In various embodiments, the polarizer 1610 may be electronically or computer controlled. The polarizer may have varying degrees of polarization which may be electronically controlled. In some embodiments, a light channel, such as a fiber optic cable, may receive the reflected light, and channel it to the spectrometer. In some embodiments, the light source may be a white light source with collimated light. In some embodiments, the light source may have a different spectrum of wave lengths.

In various embodiments, the light may project up through the bottom of a sample container such as a cuvette, a flat bottom multi-well plate, test tube, or beaker. A white light source (e.g. LED) may be collimated by a lens, optionally polarized by a computer-controlled polarizer and reflected light is focused by the same lens and collected by a light sensor (CCD) or fiber optical cable, which may be connected to a spectrometer.

In an embodiment, the grating coupled SPR measurement system may use at least one of the principles as described herein. A microchannel well plate with a flat bottom may be used as the test container, where the grating chip is placed on a z-motion stage and dipped into the test container (a cuvette or flat bottom well plate in this example). Below the bottom of the test container, a lens serves both as a collimator and a focuser, collimating the light from a white-light source (e.g. LED). The reflection from the grating surface may be focused onto one end of a fiber optic cable, with the other end of the fiber optic cable connected to a spectrometer, which measures both the reference feature and plasmonic resonance. The grating chip carrier may be moved upwards out of the test container and a stage may be moved by a positioner so a new test container may be measured. In an embodiment, the test container may be a multi-well plate, allowing as many tests as wells of the plate. Each well may be tested individually, by moving the grating chip carrier from well to well, or each may be measured simultaneously by using a corresponding number of grating chip carriers for the number of wells. In some embodiments, there may be a number of grating chip carriers corresponding to the number of rows or columns of the well plate, so that a group of wells less than the total number may be measured at once. By such successive measurements in wells containing different buffers or samples, a complex affinity measurement protocol may be implemented. This allows small amounts (<50 microliters) of sample to be tested, and the measurements can be parallelized through the use of multichannel spectrometers, allowing high throughput molecular binding characterization.

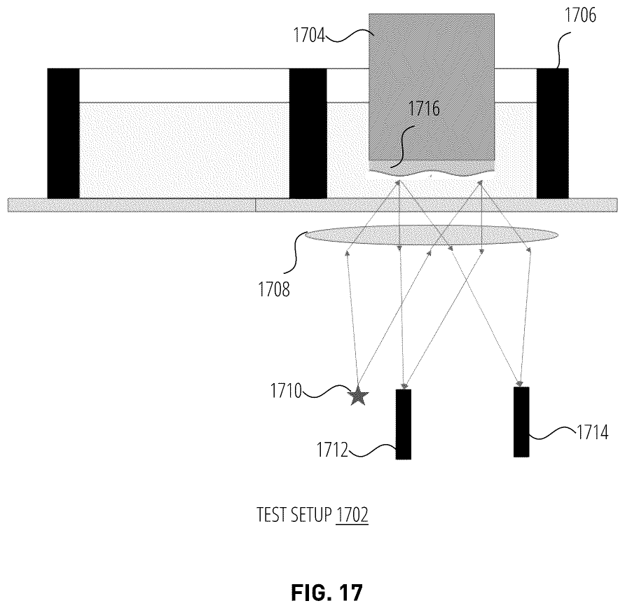

FIG. 17 illustrates an alternative aspect a test setup 1702 as part of the system described herein. In an embodiment, there may be a thin film stack 1716 attached to a carrier 1704. The carrier 1704 may be a movable object. A test container may be a flat wall test chamber 1706. a light source 1710 may project light through a lens 1708, causing the light to scatter and reflect off the thin film stack with a biofilm. The reflected light maybe detected by a diffracted light optical sensor 1712 and a spectrometer 1714. In various embodiments, The diffraction index may be used as a reference point. The diffracted light optical sensor 1712 and the spectrometer 1714 may detect light in an optical cone. Each may be able to receive light in a cone of +/−60 degrees from normal. In an embodiment, a test setup 1702 was able to register incoming light at 20 degrees off axis and still operate as intended. This provides an advantage over other systems that are currently in use, as current systems generally have to receive light at essentially 90 degree angles from the plane of the sensor. These systems are sensitive to vibration, which may prevent the reading of reflected light. The present disclosure is more tolerant of vibration. In an embodiment, the multispectral sensor may be an array, with multichannel photo detection. Each channel may be sensitive to a particular wavelength (or range of wavelengths) of light.

In various embodiments, the measurement configuration when the grating may be mounted on a carrier and immersed in a test container, such as a cuvette or well-plate with a flat and transparent window. A white light source (e.g. LED) may be collimated by a lens, optionally polarized by a computer-controlled polarizer and reflected light may be focused by the same lens and collected by a fiber optical cable, which may be connected to a spectrometer. An additional fiber optic cable may be used to collect the diffracted light at a different angle. The dominant wavelength of the diffracted light may not depend on molecular film adsorption but may depend on buffer refractive index, and therefore may be used as a reference of the background refractive index of the buffer.

In an embodiment, an additional fiber optic cable may be included to collect the diffracted order. By measuring the dominant wavelength of the diffracted order, a background refractive index measurement may be made and used as a reference for the SPR peak shift. The background refractive index and organic film thickness may then be separately identified.

In an embodiment, there may be a system for surface plasmon resonance sensor measurement, the system has a grating with at least one period selected based on a given angle of incidence so a plasmon resonance is observed in an optical reflection spectrum, or a diffracted spectrum, with a resonance peak having a wavelength sensitivity X nm/RIU (refractive index units) compared to the background refractive index. The system may also have a receptacle for receiving a test sample. The system may have a light source capable of exciting the grating surface at a given bias angle chosen so that a change in the refractive index of a buffer or an analyte, results in an observed wavelength sensitivity of −X nm/RIU due to refraction. The system may have a spectrometer positioned to capture reflected light off the grating and a computer controller that may operate any one or more of; the light source, the receptacle or the spectrometer in order to perform a surface plasmon resonance sensor measurement of the test sample.

In some embodiments the system may have an optical diffraction sensor able to capture light at a different angle than the angle of incidence and/or the angle of reflection. The computer controller may operate the optical diffraction sensor.

In yet another embodiment, there may be a method for detection of a test sample using a surface plasmon resonance detection system. The method involves placing the test sample in to a receptacle then transmitting a beam of light, via a light source, through the test sample and to a thin film stack, wherein the beam of light is off an orthogonal axis of the thin film stack. The method may involve receiving, via a spectrometer, a first reflected light off the thin film stack, and may involve receiving, via a diffraction sensor, a second reflected light. An analysis may be performed by a computer controller, where the first and second reflected lights may be used to determine if the test sample contains a molecular analyte wherein the surface plasmon resonance may be used to determine the presence or concentration of the molecular analyte.

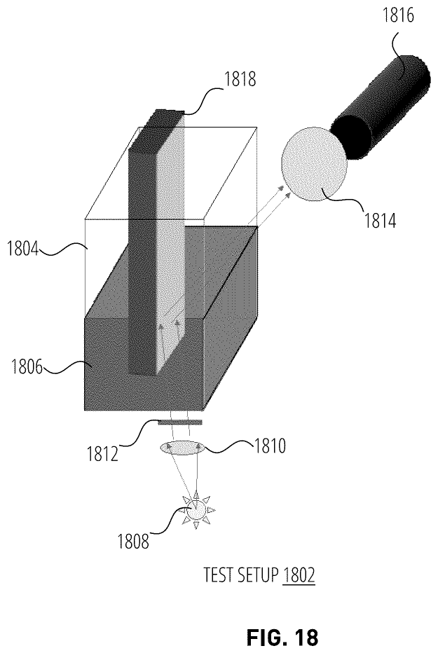

FIG. 18 illustrates a schematic representation of test setup 1802 according to an alternative embodiment of the measurement system when the grating may be mounted on a carrier and immersed in a flat wall chamber 1804 with a flat and transparent window. A light source 1808 (e.g. LED) may pass through a collimating lens 1810 and a polarizer 1812. The polarized light may pass through the flat wall chamber 1804, through a buffer or analyte 1806 and reflect off the metal coated grating substrate 1818 (a thin film stack). The reflected light may then pass through a focusing lens 1814 before being detected by an optical sensor 1816.

In some embodiments, the light source 1808 may be a white light. In some embodiments, the polarizer 1812 may be electronically controlled, so the polarization may be set by a computer program or electronic interface for a user. In some embodiments, the optical sensor may be a spectrometer, a diffracted light sensor. A light channel, such as an optical cable, may be used to channel light from a point after the focusing lens, to one or more of the optical sensors 1816. In various embodiments, the entry and exit of the light may be from the sides of the test container, and may be perpendicular to the grating plane. This configuration may be used to implement the refraction compensated, background insensitive SPR measurements. The angle of incidence, the angle of bias and/or the grating of the metal coated grating substrate, may be inter-related, so maximum effectiveness of the various embodiments may be achieved by optimizing the angle of approach (of light into the test chamber), and the angle or reflection (of light out of the test chamber), as well as the angle of reflection off the thin film stack. In some embodiments, a polarizer may be used on the back end to allow selection of TE or TM light. A reference signal may be used for making a standard, then adjustments made to make a TE or TM analysis. The standard may be determined using a diffraction light index.

In an embodiment, a perspective view of the measurement configuration shown in FIG. 2 is shown, where the grating may be mounted or fabricated on a substrate and immersed into a test container with the buffer or sample. The grating substrate may be mounted on a movable platform and lifted up, followed by switching to a new test container. In such a manner a complex binding assay may be performed using similar test containers, each test container may be filled with different buffers, reagents or analytes.

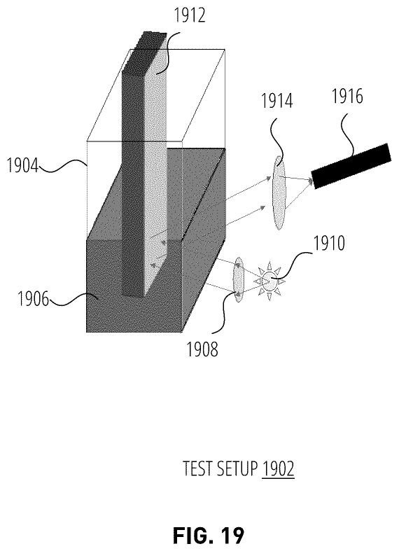

FIG. 19 illustrates a schematic test setup 1902 of the measurement configuration when the grating is mounted on a carrier and immersed in a test container with a flat and transparent window according to an embodiment. This configuration has some optical similarity to other configurations previously described. In an embodiment, a secondary optical fiber (or light channel) may be used to collect the diffracted light and use the optical signal for referencing purposes.

In an embodiment, the test setup 1902 may use a flat wall test chamber 1904 containing a liquid buffer or analyte 1906 solution. A light source 1910 may project through a collimating lens 1908 as the light enters the flat wall test chamber 1904 and reflects off the thin film stack 1912. The reflected light may pass through a focusing lens 1914 and be detected by an optical sensor 1916. In some embodiments, a light channel, such as a fiber optic cable, may channel the light to the optical sensor, so the foot print of the light detection portion of the test setup 1902 may remain small at the point of testing.

According to an aspect, a perspective view of the measurement configuration is shown, where the grating may be mounted or fabricated on a substrate and immersed into a test container containing the buffer or sample. The grating substrate may be mounted on a movable platform and lifted up, followed by switching to a new test container. In such a manner a complex binding assay may be performed using identical test containers filled with different buffers, reagents or analytes.

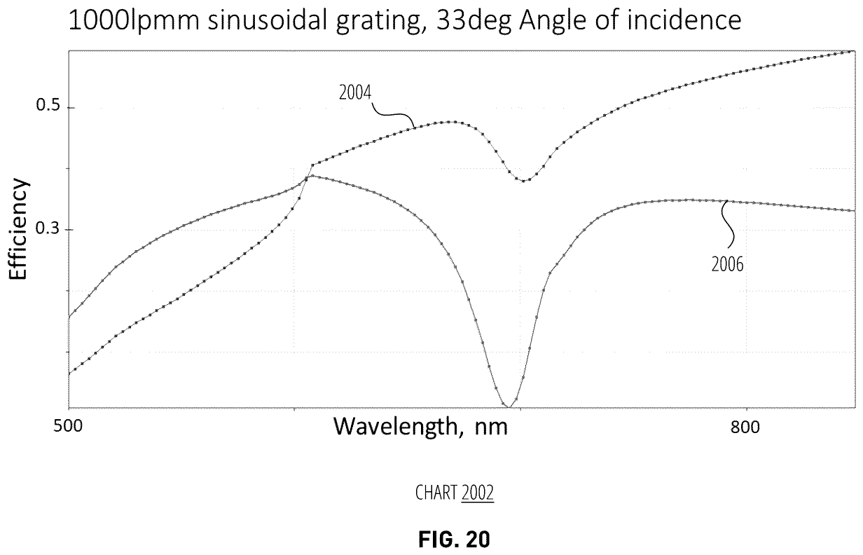

FIG. 20 illustrates a chart showing a calculation demonstrating diffracted orders that may also exhibit the signature of the plasmon resonance. In an embodiment, the light may be diffracted at a different angle than the angle of incidence, allowing flexibility in the design of the optical system.

According to an embodiment, a calculation of the reflected (0th order 2004) and diffracted (−1st order 2006) orders as a function of wavelength are shown. In this diffraction configuration the excitation light and the measurement light may have different angles, thereby giving greater flexibility in the optical design of the readout system as well as the grating depth or nanostructure. Here a 33 degree angle of incidence is used. The diffracted light exhibits the plasmon resonance dip strongly, while showing a small reference feature, while the reflected beam exhibits a strong reference feature and a weak plasmonic feature. By measuring both reflected and diffracted beams, it may be possible to measure both the background refractive index and the adsorbed film effect with high signal-to-noise ratio. The calculation is done using 1000 lines per square millimeter grating.

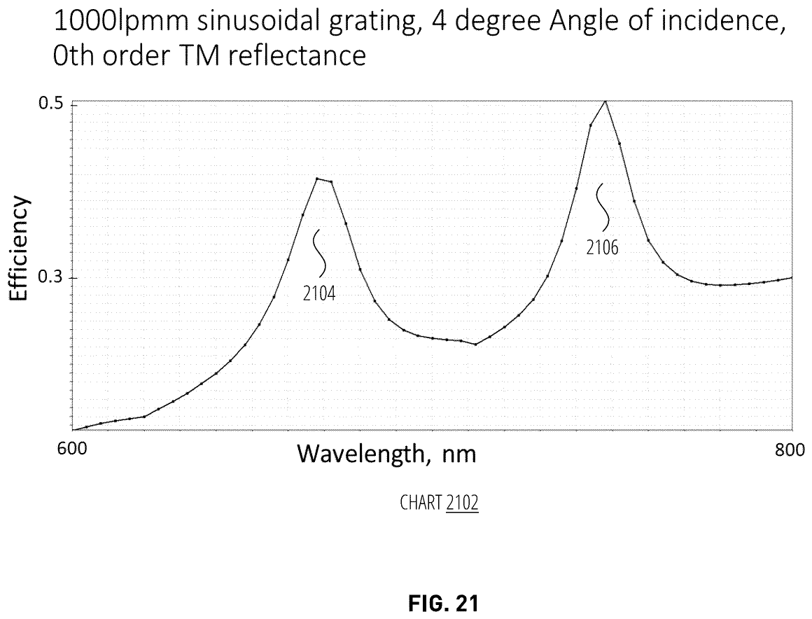

FIG. 21 illustrates a chart 2102 showing an alternative embodiment with a calculation of the reflection off a 1000 lines per millimeter sinusoidal grating in water at an angle of incidence of 4 degrees, exhibiting plasmon enhanced diffraction, where plasmonic resonances may be observed as peaks instead of dips in the reflection spectra. In an embodiment, there is a plasmonic resonance #1 2104 and a plasmonic resonance #2 2106. This plasmon enhanced diffraction phenomenon may be used to infer the peak positions for the two resonances and Eq. 14A-B may be used to infer the background refractive index and adsorbed film thickness.

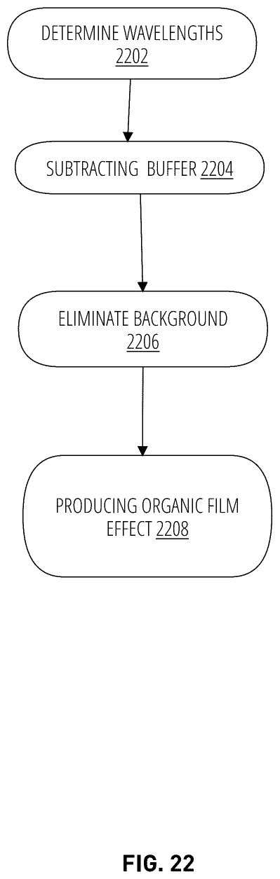

A method is provided, according to an embodiment and shown in FIG. 22. In an embodiment, there is a method of plasmon resonance analysis. The method involves a process of determining, via a processor, a plurality of wavelengths of a reference feature and a plasmon resonance feature by performing a curve fitting operation. The method also involves subtracting, via the processor, an effect of a buffer refractive index on a plasmon resonance from an organic film effect. The method may eliminate, via the processor, a background refractive index. Then the method produces, via the processor, an organic film effect on the plasmon resonance, free of the background refractive index.

Additional embodiments of the disclosure are now described in the following aspects:

1. A plasmon resonance sensor according to an aspect, the sensor comprising:
a substrate;
a surface layer of plasmonic material such as gold or silver positioned on the substrate, patterned in the form of a relief grating of a period L;
wherein the period L is chosen such that the diffraction of light from the grating and the plasmonic absorption can be simultaneously observed in the reflectance spectrum in the visible wavelength range of 400 nm to 800 nm when illuminated with an angle of incidence between 0 to 85 degrees.

2. A plasmon resonance sensor according to aspect 1, the sensor comprising:
a receptacle for receiving a sample container;
a collimated wideband excitation light source incident onto the sensor surface when it is in the sample container;
a fiber optic cable connected to a spectrometer or a multispectral photodiode that measures the wavelength dependent reflectance from the sensor surface;
the angle of incidence of the light source chosen such that the reflectance at a specific wavelength that is sensitive to the sample buffer refractive index can be measured by the fiber optic coupled spectrometer or multispectral photodiode;
the angle of incidence of the light source simultaneously satisfies the condition that the plasmon resonance can be measured independently at a different wavelength.

3. A system for surface plasmon resonance sensor measurement according to an aspect, the system comprising:
a stage for receiving a test sample;
a reflectance measurement assembly positioned on a first side of the stage, the reflectance measurement assembly comprising:
a housing having an aperture for the transmission and receiving of light;
a light emitting diode (LED) positioned to transmit light through the aperture;
a polarizer positioned to polarize the transmitted light;
a multispectral integrated sensor for detecting light; and
a polarizer positioned to polarize the detected light;
a plasmonic sensor positioned on a second side of the stage, the plasmonic sensor comprising:
a substrate;
a thin film stack with a gold (Au) plasmonic layer patterned with a surface relief grating;
wherein the plasmonic sensor and angle of incidence of reflectance is configured to optimize for the reflective wavelengths that are sensitive to a test analyte or a buffer.

4. A system for surface plasmon resonance sensor measurement, the system comprising:
a grating whose period is chosen such that for a given angle of incidence a plasmon resonance can be observed in the optical reflection spectrum, or diffracted spectrum, whose resonance peak has a wavelength sensitivity X nm/RIU (refractive index units) to the background refractive index;
a rectangular or square cuvette that houses the sample to be analyzed, when the grating is immersed into it;
a collimated white-light excitation source exciting the grating surface at a given bias angle chosen so that the changes in refractive index of the buffer result in a observed wavelength sensitivity of −X nm/RIU due to refraction (Snell's law), thereby eliminating the dependence of the observed plasmon resonance on the background refractive index;
an optional electronically controlled polarizer to select transverse magnetic or electric polarization from the reflected light from grating surface, positioned before the collection fiber; and
a fiber optic cable connected to a spectrometer, optionally with a focusing lens to collect the reflected light from the grating.

5. A grating coupled surface plasmon resonance sensor measurement method comprising:
a grating whose period is chosen such that for a given angle of incidence a plasmon resonance can be observed in the optical reflection spectrum, or diffracted spectrum, along with a step-like reference feature in the spectrum that is sensitive to the background refractive index;
a rectangular or square cuvette, or well-plate that houses the sample to be analyzed, when the grating is immersed into it;
a collimated white-light excitation source exciting the grating surface at a given bias angle chosen so that the plasmon resonance and reference feature can be simultaneously observable in the spectrum;
an optional electronically controlled polarizer to select transverse magnetic or electric polarization from the reflected light from the grating surface, positioned before the collection fiber;
a fiber optic cable connected to a spectrometer, optionally with a focusing lens to collect the reflected light from the grating; and
a data analysis software that determines the wavelengths of the reference feature and the plasmon resonance by curve fitting, and subtracting the effect of the buffer refractive index on the plasmon resonance from the organic film effect to eliminate the background refractive index, thereby giving the organic film effect on plasmon resonance, free of background.

6. A grating coupled surface plasmon resonance sensor measurement method comprising:
a grating whose period is chosen such that for a given angle of incidence a plasmon resonance can be observed in the optical reflection spectrum, or diffracted spectrum, along with a step-like reference feature in the spectrum that is sensitive to the background refractive index;
a rectangular or square cuvette, or well-plate that houses the sample to be analyzed, when the grating is immersed into it;
a collimated white-light excitation source exciting the grating surface at a given bias angle chosen so that the plasmon resonance and reference feature can be simultaneously observable in the spectrum;
an optional electronically controlled polarizer to select transverse magnetic or electric polarization from the reflected light from the grating surface, positioned before the collection fiber;
a fiber optic cable connected to a spectrometer, optionally with a focusing lens to collect the reflected light from the grating;
a secondary fiber optic cable to collect the diffracted light at a different angle than the angle of incidence or reflection; and
a data analysis software that determines the wavelengths of the diffracted light and the plasmon resonance by curve fitting, and subtracting the effect of buffer refractive index from the organic film effect on plasmon resonance to eliminate the background refractive index, thereby giving the organic film effect, free of background.

7. A grating coupled surface plasmon resonance sensor measurement method comprising:
a grating whose period is chosen such that for a given angle of incidence multiple plasmon resonances can be observed in the optical reflection spectrum, or diffracted spectrum;
a rectangular or square cuvette, or well-plate that houses the sample to be analyzed, when the grating is immersed into it;
a collimated white-light excitation source exciting the grating surface at a given bias angle chosen so that the plasmon resonances can be simultaneously observable in the spectrum;
an optional electronically controlled polarizer to select transverse magnetic or electric polarization from the reflected light from the grating surface, positioned before the collection fiber;
a fiber optic cable connected to a spectrometer, optionally with a focusing lens to collect the reflected light from the grating;
a secondary fiber optic cable to collect the diffracted light at a different angle than the angle of incidence or reflection; and
a data analysis software that determines the wavelengths of the plasmon resonances by curve fitting, and subtracting the effect of buffer refractive index from the organic film effect on plasmon resonance by solving the linear or nonlinear equations that relate the shifts of the multiple plasmon peak wavelengths to the buffer refractive index and organic film thickness, thereby giving the organic film effect, free of background.

8. A system for measurement for plasmonic measurement of biomolecular adsorption free of background index interference, using methods of claims 1, 2, 3, comprising:
a manual or computer controlled horizontal positioning platform that moves a series of cuvettes or well-plate below the plasmonic grating;
a manual or computer controlled vertical positioning platform that immerses the grating into the wells or cuvettes;
a holder that carries the plasmonic grating;
a light source;
an optionally a computer-controlled polarizer that is placed in the light path, that can be used to measure TE and TM polarizations and use their ratio for eliminating spectral variations or intensity fluctuations of light source;
a collection lens that focuses reflected light from the grating onto a fiber optic cable;
at least one or more spectrometers to measure spectra of reflected light from the grating;
analysis software to calculate and subtract the background refractive index of the analyte from the plasmon resonance shift, giving the organic film absorption related shift; and
a control software to move positioning stages, control polarization or intensity of light source and record measurements from spectrometers, perform data analysis and to apply a complex sequence of measurements from different buffers, reagents or analytes in different wells or cuvettes.

9. A system for measurement for measurement of biomolecular adsorption, comprising:
a substrate with a silicon wafer as base layer, 100-140 nm thick sio₂ as second layer, 0.5-1.5 nm chromium (Cr) adhesion layer and 1-5 nm Au molecular binding layer;
a manual or computer controlled vertical positioning platform that immerses the said substrate into the wells or cuvettes;
a light source, and a multispectral photodiode array or fiber coupled spectrometer that measures the reflection from the substrate surface;
an analysis software to calculate and subtract the background refractive index of the analyte from the plasmon resonance shift, giving the organic film absorption related shift; and
a control software to move positioning stages, control intensity of light source and record measurements from multispectral photodiode array or spectrometers, perform data analysis and to apply a complex sequence of measurements from different buffers, reagents or analytes in different wells or cuvettes.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer program instructions, encoded on one or more computer storage medium for execution by, or to control the operation of, data processing apparatus, such as a processing circuit. A controller or processing circuit such as CPU may comprise any digital and/or analog circuit components configured to perform the functions described herein, such as a microprocessor, microcontroller, application-specific integrated circuit, programmable logic, etc. Alternatively or in addition, the program instructions may be encoded on an artificially generated propagated signal, e.g., a machine-generated electrical, optical, or electromagnetic signal, that is generated to encode information for transmission to suitable receiver apparatus for execution by a data processing apparatus.

A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium may also be, or be included in, one or more separate components or media (e.g., multiple CDs, disks, or other storage devices). Accordingly, the computer storage medium is both tangible and non-transitory.

The operations described in this specification may be implemented as operations performed by a data processing apparatus on data stored on one or more computer-readable storage devices or received from other sources. The term “data processing apparatus” or “computing device” encompasses all kinds of apparatus, devices, and machines for processing data, including by way of example a programmable processor, a computer, a system on a chip, or multiple ones, or combinations, of the foregoing. The system or apparatus may include special purpose logic circuitry, e.g., an FPGA (field programmable gate array) or an ASIC (application specific integrated circuit). The apparatus may also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing and grid computing infrastructures.

A computer program (also known as a program, software, software application, script, or code) may be written in any form of programming language, including compiled or interpreted languages, declarative or procedural languages, and it may be deployed in any form, including as a standalone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments of the subject matter described in this specification may be implemented on a computer having a display device, e.g., a CRT (cathode ray tube) or LCD (liquid crystal display) monitor, OLED (organic light emitting diode) monitor or other form of display for displaying information to the user and a keyboard and/or a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

While the foregoing written description may enable one of ordinary skill to make and use what is considered presently to be the best mode thereof, those of ordinary skill will understand and appreciate the existence of variations, combinations, and equivalents of the specific embodiment, method, and examples herein. The present disclosure should therefore not be limited by the above described embodiment, method, and examples, but by all embodiments and methods within the scope and spirit of the present disclosure.

Although the disclosure has been explained in relation to its many aspects and embodiments, it is to be understood that many other possible modifications and variations can be made without departing from the spirit and scope of the disclosure.

What is claimed is:

1. A method for detection of a test sample using a surface plasmon resonance detection system, the method comprising:
placing the test sample in to a receptacle;
transmitting a beam of light, via a light source, through the test sample and to a thin film stack, wherein the beam of light is off an orthogonal axis of the thin film stack;
receiving, via a spectrometer, a first reflected light off the thin film stack;
receiving, via a diffraction sensor, a second reflected light; and
analyzing, via a computer controller, the first and second reflected lights to determine if the test sample contains a molecular analyte wherein the surface plasmon resonance is used to determine the presence of the molecular analyte.

2. The method for detection of claim 1, wherein the thin film stack has a silicon base layer, a silicon dioxide intermediate layer, a chromium bonding layer, and a metal grating layer.

3. The method for detection of claim 2, wherein the metal grating layer has a period corresponding to an angle of incidence so a plasmon resonance is observed in an optical reflection spectrum or a diffraction spectrum, where a resonance peak has a wavelength sensitivity of X nm/RIU (refractive index units) as compared to a background refractive index.

4. The method for detection of claim 2, further comprising selecting a grating for the metal grating layer, wherein the selecting a period is chosen so a given angle of incidence a plasmon resonance is observed in the optical reflection spectrum, or the diffracted spectrum, along with a step-like reference feature in the optical reflection spectrum, or the diffracted spectrum, that is sensitive to a background refractive index.

5. A system for surface plasmon resonance sensor measurement, the system comprising:
a grating with at least one period selected based on a given angle of incidence so a plasmon resonance is observed in an optical reflection spectrum, or a diffracted spectrum, with a resonance peak having a wavelength sensitivity X nm/RIU (refractive index units) compared to the background refractive index;
a receptacle for receiving a test sample;
a light source capable of exciting the grating surface at a given bias angle chosen so that a change in the refractive index of a buffer or an analyte, results in an observed wavelength sensitivity of −X nm/RIU due to refraction;
a spectrometer positioned to capture reflected light off the grating; and
a computer controller, wherein the computer controller operates the light source, the receptacle or the spectrometer in order to perform a surface plasmon resonance sensor measurement of the test sample.

6. The system of claim 5, wherein the light source is a collimated white light source.

7. The system of claim 6, wherein the test sample is contained in a container having a flat surface for transmission of light energy.

8. The system of claim 5, further comprising a diffracted light sensor.

9. The system of claim 7, further comprising a light channel for receiving the optical reflection spectrum or the diffracted spectrum, and channeling the light to the spectrometer or the diffracted light sensor.

10. The system of claim 9, wherein the light channel for receiving the diffracted spectrum is positioned at a different angle than an angle of incidence or an angle of reflection.

11. The system of claim 6, wherein the collimated white light source causes the excitation of the grating surface at a bias angle chosen so that a plasmon resonance feature and a reference feature are simultaneously observable in the optical reflection spectrum or the diffracted spectrum.

12. The system of claim 5, further comprising a polarization filter.

13. The system of claim 12, wherein the polarization filter is electronically controlled by the computer controller.

14. The system of claim 12, wherein the polarization filter is selected to transverse magnetic or electric polarization from the reflected light from the grating surface, positioned before the spectrometer, diffraction sensor or light channel.

15. The system of claim 5, wherein the computer controller further comprises a data analysis software able to determine the wavelengths of the reference feature and the plasmon resonance by performing a curve fitting operation, and subtracting an effect of a buffer refractive index on the plasmon resonance from a organic film effect to eliminate the background refractive index.

16. The system of claim 5, wherein the grating has more than one period.

17. The system of claim 5, further comprising a motor for moving the receptacle for receiving the test sample, wherein the motor is operated by the computer controller.

18. A method of plasmon resonance analysis, the method comprising:
determining, via a processor, a plurality of wavelengths of a reference feature and a plasmon resonance feature by performing a curve fitting operation;
subtracting, via the processor, an effect of a buffer refractive index on a plasmon resonance from an organic film effect;
eliminating, via the processor, a background refractive index; and
producing, via the processor, an organic film effect on the plasmon resonance, free of the background refractive index.
